(19) United States
(12) Patent Application Publication
(10) Pub. No.: US 2026/0122332 A1
(43) Pub. Date: Apr. 30, 2026

(54) DESIGN METHOD OF IMAGE SENSOR

(71) Applicant: SAMSUNG ELECTRONICS CO., LTD., Suwon-si (KR)

(72) Inventors: Daejung KIM, Suwon-si (KR); Yujung CHOI, Suwon-si (KR)

(73) Assignee: SAMSUNG ELECTRONICS CO., LTD., Suwon-si (KR)

(21) Appl. No.: 19/074,893

(22) Filed: Mar. 10, 2025

(30) Foreign Application Priority Data
Oct. 24, 2024 (KR) 10-2024-0146324

(51) Int. Cl. H04N 23/55

(52) U.S. Cl. CPC H04N 23/55

(57) ABSTRACT

A design method of an image sensor, includes: determining a degree of similarity between specification data of each of a plurality of image sensors in a database and specification data of the image sensor to be designed; selecting, based on the specification data of the image sensor to be designed and the degree of similarity with the image sensor to be designed, at least two image sensors from among the plurality of image sensors, wherein the at least two image sensors correspond to design model candidates; selecting a design model to be verified by combining the design model candidates corresponding to the at least two image sensors and verifying whether the design model to be verified operates normally; and selecting the design model to be verified, which is operating normally, as a final design model.

### CROSS-REFERENCE TO RELATED APPLICATION

This application is based on and claims priority under 35 U.S.C. § 119(a) to Korean Patent Application No. 10-2024-0146324, filed on Oct. 24, 2024, in the Korean Intellectual Property Office, the disclosure of which is incorporated herein by reference in its entirety.

### BACKGROUND

The disclosure relates to a design method of an image sensor.

A design of an image sensor may be divided into a pixel design and a circuit design, and the circuit design may include an analog circuit design and a digital circuit design. As various specifications of the image sensor are required, the design of the image sensor may become complex. This would increase the time required to design an image sensor. In addition, whether the designed image sensor meets the required specifications may be an important factor in terms of the performance and design reliability of the image sensor.

### SUMMARY

Provided is a design method of an image sensor of automatically designing an image sensor using design data of an image sensor that has been designed and further shortening the time required for designing an image sensor and improving the design quality of the image sensor.

According to an aspect of the disclosure, a design method of an image sensor, includes: determining a degree of similarity between specification data of each of a plurality of image sensors in a database and specification data of the image sensor to be designed; selecting, based on the specification data of the image sensor to be designed and high degrees of similarity with the image sensor to be designed, at least two image sensors from among the plurality of image sensors, wherein the at least two image sensors correspond to design model candidates; selecting a design model to be verified by combining the design model candidates corresponding to the at least two image sensors and verifying whether the design model to be verified operates normally; and selecting the design model to be verified, which is operating normally, as a final design model.

According to an aspect of the disclosure, a design method of an image sensor, includes: determining a degree of similarity between specification data of each of a plurality of image sensors in a database and specification data of the image sensor to be designed; selecting, based on the degree of similarity, a pixel model candidate and a circuit model candidate, from among design models of each of the plurality of image sensors in the database; verifying each of the pixel model candidate and the circuit model candidate, merging the pixel model candidate and the circuit model candidate, and verifying whether the merged model candidate operates normally; and merging the pixel model candidate and the circuit model candidate that are verified and selecting the merged pixel model candidate and the circuit model candidate as a final design model of the image sensor to be designed.

According to an aspect of the disclosure, a design method of an image sensor, includes: a first design step of selecting a driving unit pixel for each of pixel models and circuit models, using specification data and design models of each of a plurality of images in a database, and generating a single row or a single column by repeatedly disposing a design of the driving unit pixel; a second design step of generating a row layout or a column layout by merging and repeatedly disposing the pixel models and the circuit models for the single row or the single column; a first verification step of verifying a structure of the row layout or the column layout; a third design step of generating a pixel array and peripheral circuits using the row layout or the column layout, reflecting a special pixel and a special circuit, and performing a special function into each of the pixel array and the peripheral circuits; a second verification step of verifying a performance of the special function of the pixel array and the peripheral circuits in which the special pixel and the special circuit are reflected; and an overall verification step of merging the pixel array and the peripheral circuits in which the special pixel and the special circuit are reflected and verifying whether the merged circuit operates normally.

### BRIEF DESCRIPTION OF DRAWINGS

The above and other aspects, features, and advantages of the disclosure will be more clearly understood from the following detailed description, taken in conjunction with the accompanying drawings, in which:

FIG. 1 illustrates an image sensor according to an example embodiment of the disclosure;

FIG. 2 illustrates a pixel array structure of an image sensor according to an example embodiment of the disclosure;

FIG. 3 illustrates a structure of a pixel included in an image sensor according to an example embodiment of the disclosure;

FIG. 4 illustrates an image sensor design system according to an example embodiment of the disclosure;

FIG. 5 illustrates a process for selecting a final design model of an image sensor design system according to an example embodiment of the disclosure;

FIG. 6 illustrates a design model candidate and a design model to be verified according to an example embodiment of the disclosure;

FIG. 7 illustrates selection and verification of a design model to be verified according to an example embodiment of the disclosure.

FIGS. 8 and 9 illustrate a pixel model and an analog circuit model for a driving unit pixel according to example embodiments of the disclosure;

FIG. 10 illustrates a process of classifying and storing design data according to an example embodiment of the disclosure; and

FIG. 11 illustrates an image sensor design system according to example embodiments of the disclosure.

### DETAILED DESCRIPTION

Hereinafter, example embodiments of the disclosure will be described with reference to the attached drawings.

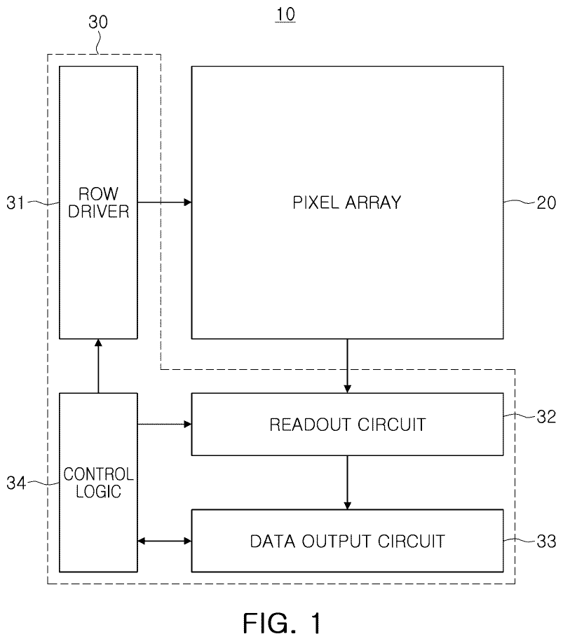

FIG. 1 illustrates an image sensor according to an example embodiment of the disclosure.

Referring to FIG. 1, an image sensor 10 according to an example embodiment of the disclosure may include a pixel array 20 and a peripheral circuit 30 and the like.

The pixel array 20 may include a plurality of pixel regions disposed in an array form in a plurality of rows and a plurality of columns. A photoelectric conversion element generating a charge in response to light may be disposed in each of the plurality of regions, and the photoelectric conversion element may be connected to a pixel circuit generating and outputting a signal corresponding to the charge generated by the photoelectric conversion element. A pixel may be implemented by a photoelectric conversion element and a pixel circuit. The photoelectric conversion element may include a photodiode formed of a semiconductor material, and/or an organic photodiode formed of an organic material.

For example, the pixel circuit may include a plurality of transistors. A capacitor may store charge excessively generated by a photodiode, and may be connected to a photodiode through at least one transistor. As another example, the pixel circuit may further include a capacitor. The capacitor may be a Metal-Insulator-Metal (MIM) capacitor, a Metal-Oxide-Semiconductor (MOS) capacitor, or a Lateral Over-Flow Integration Capacitor (LOFIC) capacitor.

The peripheral circuit 30 may include circuits for controlling the pixel array 20. For example, the peripheral circuit 30 may include a row driver 31, a readout circuit 32, a data output circuit 33, a control logic 34, and the like. The row driver 31 may drive the pixel array 20 in units of row lines. For example, the row driver 31 may input control signals for controlling an on/off state of each of the transistors included in the pixel circuit to the pixel array 20 in units of row lines.

Among the pixels, pixels disposed at the same position in a row direction (a horizontal direction of FIG. 1) may share the same column line. For example, pixels disposed at the same position in a column direction (a vertical direction of FIG. 1) may be simultaneously selected by the row driver 31 and output pixel signals through the column lines. In an example embodiment, the readout circuit 32 may simultaneously receive signals from pixels selected by the row driver 31 through the column lines. For example, the readout circuit 32 may sequentially receive a reset voltage and a signal voltage from each of the pixels, and the signal voltage may be a voltage in which a charge generated from a photodiode of each of the pixels is reflected in the reset voltage.

The readout circuit 32 may include a plurality of correlated dual samplers and a plurality of counters, and the correlated dual samplers may be connected through pixels and column lines. For example, one correlated dual sampler and one counter may be connected to one column line. The correlated dual samplers may read a voltage signal from pixels connected to a row line selected by a row line select signal of the row driver 31 through column lines. One input terminal among input terminals of each of the correlated dual samplers may be connected to the column lines, and the other input terminal may receive a lamp voltage.

An output terminal of each of the correlated dual samplers may be connected to counters, and the counters may generate a digital pixel signal by counting the time during which an output of each of the correlated dual samplers is maintained at a specific voltage. For example, the counter may convert the output of the correlated dual sampler into a digital pixel signal by counting the time during which the lamp voltage input to the correlated dual sampler is greater than a voltage of the column line. The data output circuit 33 may include a memory such as a latch or a buffer circuit that temporarily stores the digital pixel signal.

The control logic 34 may include a timing controller, or the like for controlling an operation timing of the row driver 31, the readout circuit 32, and the data output circuit 33. Depending on the embodiment, the control logic 34 may determine a data format output by the data output circuit 33, or perform preprocessing of the data to be output by the data output circuit 33.

In a design method of a general image sensor, a pixel array and peripheral circuits may not be designed simultaneously, but may be designed sequentially. For example, the pixel array may be designed after an analog circuit among the peripheral circuits are designed, and then, a digital circuit among the peripheral circuits may be designed. Since the image sensor is designed step by step, it may take a considerable amount of time to design the image sensor.

In an example embodiment of the disclosure, an image sensor 10 satisfying specifications may be automatically designed based on design data of a pixel array 20 and peripheral circuit 30 of a mass-produced image sensor. The design of the image sensor 10 may include a design of each of the pixel array 20 and the peripheral circuit 30, and the design of the peripheral circuit 30 may include a design of each of the analog circuit and the digital circuit. In addition, in an example embodiment of the disclosure, since the pixel array 20 and peripheral circuit 30 of the image sensor 10 are designed simultaneously, the time required to design the image sensor 10 may be shortened.

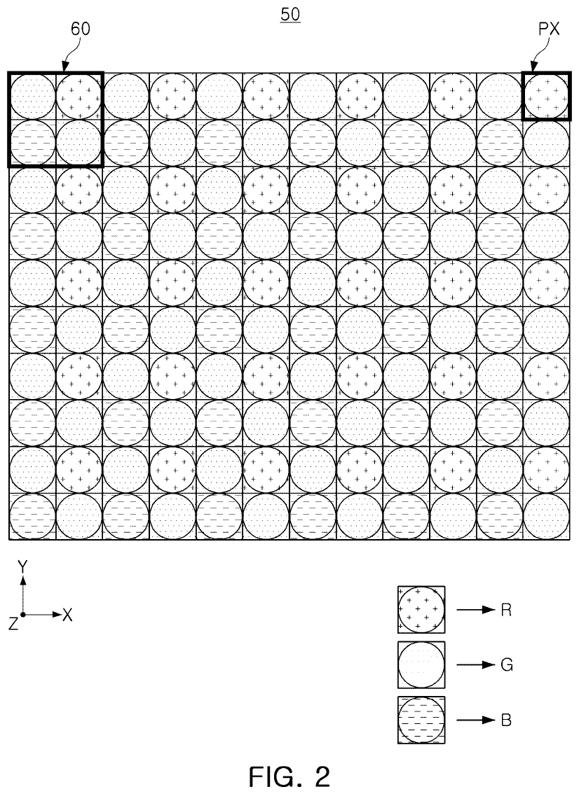

FIG. 2 illustrates a pixel array structure of an image sensor according to an example embodiment of the disclosure.

Referring to FIG. 2, a pixel array 50 of the image sensor according to an example embodiment of the disclosure may include a plurality of pixels (PX) disposed in a first direction (X-axis direction of FIG. 2) and a second direction (Y-axis direction of FIG. 2). For example, the pixel array 50 may include red pixels 51, green pixels 52, and blue pixels 53.

Each of the plurality of pixels (PX) may include a color filter, and the color filter may transmit light corresponding to a wavelength of one of red, green, and blue colors. In other words, each of the plurality of pixels (PX) may include one of a red color filter, a green color filter, and a blue color filter.

The pixel array 50 may include a plurality of a portion of regions 60. Among the plurality of pixels (PX), four pixels (PX) disposed in 2×2 form may be disposed in a Bayer pattern. As illustrated in FIG. 2, among the four pixels (PX) disposed in 2×2 form, each of the two pixels (PX) disposed diagonally may include a green color filter, and each of the other two pixels (PX) may include a red color filter and a blue color filter. In this case, four pixels (PX) included in the portion of regions 60 may correspond to driving unit pixels. The driving unit pixels may correspond to the smallest unit which is operating independently.

However, the disposition of each of the plurality of pixels (PX) may not be limited as illustrated in FIG. 2. For example, four pixels (PX) disposed in 2×2 form in the first and second directions may be disposed in a tetra pattern including color filters of the same color. In this case, the portion of regions may include sixteen pixels (PX) disposed in 4×4 form, and the sixteen pixels (PX) may correspond to driving unit pixels.

In addition, unlike the example embodiment illustrated in FIG. 2, a portion of the plurality of pixels (PX) may not include a color filter, or may include a color filter transmitting light of a color, other than red, green, and blue.

Each of the plurality of pixels (PX) may include a micro lens and a photo diode. The micro lens may be disposed above the photo diode in a light-receiving region. In an example embodiment of the disclosure, by automatically designing a circuit connected to the photodiode in each of the pixel array 50 and the plurality of pixels (PX), the time required to design an image sensor may be shortened and the quality of the design may be improved.

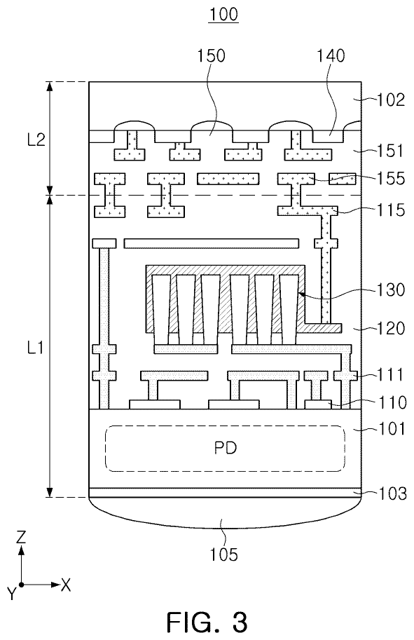

FIG. 3 illustrates a structure of a pixel included in an image sensor according to an example embodiment of the disclosure.

Referring to FIG. 3, an image sensor 100 according to an example embodiment of the disclosure may include a first layer L1 and a second layer L2. The first layer L1 and the second layer L2 may be stacked in a third direction (Z-axis direction of FIG. 3). The first layer L1 may include a first substrate 101, and a photodiode (PD) and a plurality of transistors 110 may be formed on the first substrate 101. The plurality of transistors 110 may be connected to each other by metal wirings 111 to provide a pixel circuit connected to the photodiode (PD).

Incident light may be incident on one surface of the first layer (L1). For example, the incident light may be incident in a first direction from the outside of the image sensor 100. One surface of the first substrate 101 may be utilized to dispose a plurality of transistors 110 for processing an electrical signal generated from a photodiode (PD).

Metal wirings 111 may be disposed within a first interlayer insulating layer 120 formed on one surface of the first substrate 101. A top wiring 115 disposed at the top of the first interlayer insulating layer 120 may be connected to a top wiring 155 of the second layer L2. Meanwhile, a color filter 103, a microlens lens 105, and the like, may be disposed on the other surface of the first substrate 101.

As the example embodiment illustrated in FIG. 3, a capacitor 130 may be connected to a plurality of transistors 110 and included in a pixel circuit. The capacitor 130 may be a MIM capacitor, but the type of capacitor 130 may not be limited thereto. In addition, unlike as illustrated in FIG. 3, the pixel circuit may not include a capacitor 130.

The second layer L2 may include a second substrate 102, and a plurality of transistors 140 may be formed on the second substrate 102. The plurality of transistors 140 may be connected to each other by metal wirings 151 disposed within the second interlayer insulating layer 150, thereby providing a peripheral circuit for driving a pixel array, for example, a row driver, a readout circuit, or the like. The top wiring 155 disposed at the top within the second interlayer insulating layer 150 may be connected to the top wiring 115 of the first layer L1.

In an example embodiment of the disclosure, the first layer L1 may further include a semiconductor layer formed on a portion of one surface of the first substrate 101 and a first insulating layer formed between the first substrate 101 and the semiconductor layer. The semiconductor layer may be composed of an amorphous oxide semiconductor, a 2D nanomaterial, amorphous silicon, or polysilicon. The semiconductor layer may be formed by depositing the material as a thin film on the first substrate 101.

The first insulating layer may be a Gate Oxide (Gox) insulating layer disposed between gates of the plurality of transistors 110 and a channel region. For example, the first insulating layer may be comprised of silicon dioxide (SiO₂), high-k materials, or the like.

An image sensor design system of an example embodiment of the disclosure may automatically design an image sensor 100 satisfying the specification data based on the design data of the pixel and circuit of the mass-produced image sensor. Specifically, the image sensor design system may design an image sensor by selecting a pixel and a circuit, respectively most similar to the specifications from among the design data, and disposing the pixel and the circuit.

For example, the image sensor design system may design pixels and circuits on the basis of units of driving unit pixels. Referring to FIG. 2 together, the driving unit pixels may correspond to a plurality of pixels (PX) included in a portion of regions, but an example embodiment thereof may not be limited thereto. The image sensor design system may design a pixel by considering at least one of a size of the pixel (PX), whether a micro lens is included, whether a color filter is included, and a color of the color filter among the specification data. The pixel design may include the design of the color filter 103 and the micro lens 105.

A circuit selected by the image sensor design system may include an analog circuit and a digital circuit. The analog circuit may include information on the disposition and connection of elements of the first layer L1 and the second layer L2. For example, the analog circuit may include the types and disposition of each of a photodiode (PD), a plurality of transistors 110 and 140, metal wirings 111, and top wirings 115 and 155 included in the first layer L1 and the second layer L2. The image sensor design system may select an analog circuit by including analog element types and analog element connection information among the specification data.

The digital circuit may include a clock signal and a digital pattern which operate an analog circuit. The image sensor design system may select a digital circuit, including a digital signal timing, digital data, a digital mode, and the like among specification data.

The image sensor design system of an example embodiment of the disclosure may simultaneously select a pixel, an analog circuit, and a digital circuit. Accordingly, the time required to design an image sensor may be shortened.

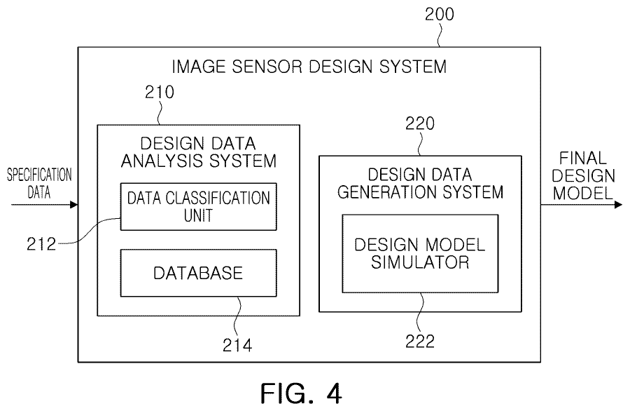

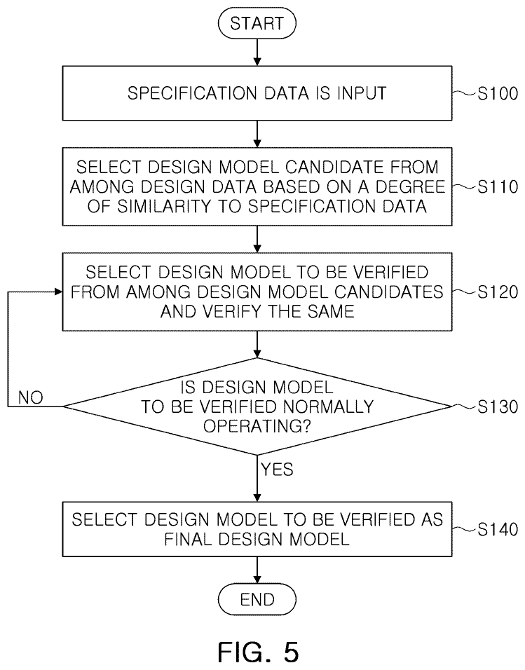

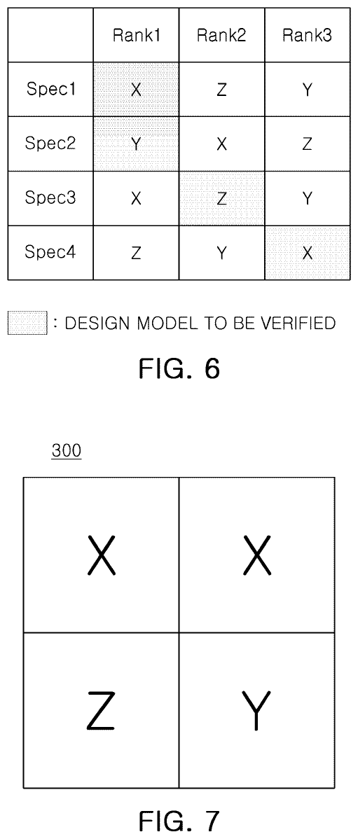

FIG. 4 illustrates an image sensor design system according to an example embodiment of the disclosure. FIG. 5 illustrates a process for selecting a final design model of an image sensor design system according to an example embodiment of the disclosure. FIG. 6 is a diagram illustrating a design model candidate and a design model to be verified according to an example embodiment of the disclosure.

First, in FIG. 4, an image sensor design system 200 may be used to design an image sensor satisfying required specification data. In an example embodiment, the image sensor design system 200 may receive specification data. The image sensor design system 200 may select a final design model from among design data of a mass-produced image sensor. The final design model may be a design result of an image sensor satisfying the specification data. The final design model may include designs for a pixel and a circuit.

In an example embodiment of the disclosure, the image sensor design system 200 may include a design data analysis system 210 and a design model generation system 220. The design data analysis system 210 may include a data classification unit 212 and a database 214. The data classification unit 212 may classify by parsing the specification data of the image sensors and the final design model. The data classified by the data classification unit 212 may be stored as design data in the database 214.

The design model generation system 220 may select a final design model based on analysis results of the design data analysis system 210. The design model generation system 220 may include a design model simulator 222. The design model simulator 222 may verify a design model, and the design model generation system 222 may select a design model that has been verified as a final design model. Hereinafter, a process by which the image sensor design system selects the final design model is described.

In some embodiments, the design data analysis system 210, the design model generation system 220, the data classification unit 212, and/or the design model simulator 222 refer to a hardware component such as a processor or a circuit, and/or a software component executed by a hardware component such as a processor. In some embodiments, the design data analysis system 210, the design model generation system 220, the data classification unit 212, and/or the design model simulator 222 may be implemented by a program that is stored in a storage medium which may be addressed, and is executed by a processor. In some embodiments, the design data analysis system 210, the design model generation system 220, the data classification unit 212, and/or the design model simulator 222 may be implemented by components such as software components, object-oriented software components, class components, and task components, processes, functions, attributes, procedures, sub-routines, segments of a program code, drivers, firmware, a micro code, a circuit, data, a database, data structures, tables, arrays, and parameters.

Referring to FIGS. 4 and 5 together, specification data of an image to be designed may be input into the image sensor system 200 (S100). The specification data may be input manually by a user, or the user may input the data in a file format. The file format may correspond to an image file, a document file, or the like.

Specifications of the image sensor may include at least one of an image sensor size, pixel size, effective resolution, typical frame rate, video frame rate, power supply, operating temperature, signal interface, autofocus, and output format, but may not be limited thereto. The specification data of the image sensor may correspond to specific data for the specifications. For example, when the specifications of the image sensor include an effective resolution, the specification data for the effective resolution may be defined as, for example, 2560×1140.

A design data analysis system 210 may select design model candidates from among the design data based on a degree of similarity to the specification data of the image sensor to be designed (S110). In other words, the design data analysis system 210 may select a design model candidate for an image sensor by specification based on the degree of similarity between the design data stored in the database 214 and the specification data of the image sensor to be designed.

The design data may include specification data of each of the image sensors that have been designed and a final design model. The design data may be stored in a database 214 and managed, and, for example, the design data may be parsed and stored in the database 214.

The design model candidate may include design data having a high degree of similarity to the specification data of the image sensor to be designed based on the specifications of the image sensor to be designed. In other words, the design model candidate may be an image sensor corresponding to the specification data having a high degree of similarity to the specification data of the image sensor to be designed. Referring to FIG. 6 together, the design model candidate may include image sensors selected from among the design data for each of the specification data of the image sensor to be designed. Each of the selected image sensors may have a high degree of similarity to the specification data of the image sensor to be designed among the specification data of the image sensors stored in the design data. For example, a design model candidate may have a diagrammatic form, but the form of the design model candidate may not be limited to the diagrammatic form.

In the example embodiment illustrated in FIG. 6, the design data may include specification data and a final design model for each of image sensors X to Y. The design data analysis system 210 may compare the specification data for each of the image sensors X to Y with first to fourth specification data (Spec1 to Spec4) of the image sensor to be designed to determine a degree of similarity.

The first to third degrees of similarities (Rank1 to Rank3) may correspond to a relative order of degrees of similarities. Specifically, the closer to the first degree of similarity (Rank1), the higher the degree of similarity between the specification data and the design data. For example, for the first specification data (Spec1), the degree of similarity may be high in the order of an image sensor X, an image sensor Z, and an image sensor Y.

The design data may also include a final design model for each of the image sensor X and image sensor Y. The design model candidate may correspond to the final design model with a high degree of similarity according to the specification data (Spec1 to Spec4) of the image sensor to be designed. The final design model may include a pixel model and a circuit model, and the circuit model may include an analog circuit model and a digital circuit model.

In the example embodiment illustrated in FIG. 6, the image sensor having the highest degree of similarity in at least one of the first to fourth specification data (Spec1 to Spec4) may be different. For example, the first and third specification data (Spec1 and Spec3) of the image sensor to be designed may have the highest degree of similarity to the first and third specification data (Spec1 and Spec3) of the image sensor X. The second specification data (Spec2) of the image sensor to be designed may have the highest degree of similarity to the second specification data (Spec2) of the image sensor Y, and the fourth specification data (Spec4) of the image sensor to be designed may have the highest degree of similarity to the fourth specification data (Spec4) of the image sensor Z. However, this may not be limited thereto.

A design model generation system 220 may receive design model candidates selected by the design data analysis system 210. Referring to FIGS. 4 and 5, the design model generation system 220 may select a design model to be verified from the design model candidates and verify the selected design model (S120). The design model generation system 220 may select one image sensor from among the design model candidates based on the specification data of the image sensor to be designed, and the design models of the image sensors selected based on the specification data may be included in the design model to be verified.

According to the example embodiment illustrated in FIG. 6, for each of the first and second specification data (Spec1 and Spec2), an image sensor X and an image sensor Y corresponding to the degree of first similarity (Rank1) may be selected. For the third specification data (Spec3), an image sensor Z corresponding to the second degree of similarity (Rank2) may be selected. For the third specification data (Spec3), an image sensor Z corresponding to the second degree of similarity (Rank2) may be selected. But the disclosure is not limited thereto.

The design model generation system 220 may perform pixel and circuit designs of an image sensor to be designed by merging an image sensor to be verified. Specifically, pixel design may be performed by merging a final design model of the image sensor corresponding to data related to the pixel design among the specification data of the image sensor to be designed. Circuit design can be performed by merging the final design model of the image sensor corresponding to data related to the circuit design among the specification data of the image sensor to be designed.

A design model simulator 222 may verify the selected design model to be verified. For example, the design model simulator 222 may verify whether a pixel array is operating in row and/or column units, disposition of the pixel array and analog circuits, and whether the image sensor is entirely operational.

When a design model to be verified does not operate normally (NO of S130), the design model generation system 220 may repeatedly perform the process of re-selecting and verifying the design model to be verified from the design model candidates (S120). When the design model to be verified is operating normally (YES of S130), the design model generation system 220 may select the design model to be verified as a final design model (S140). The final design model may be applied to the design of pixels and circuits of the image sensor to be designed.

By designing the pixels and circuits of the image sensor to be designed using the degree of similarity of design data and specification data, the time required for design and verification may be shortened. In addition, the accuracy of design and verification can be improved as compared to the method in which the user directly performs design and verification. Therefore, the efficiency and reliability of the image sensor design may be improved.

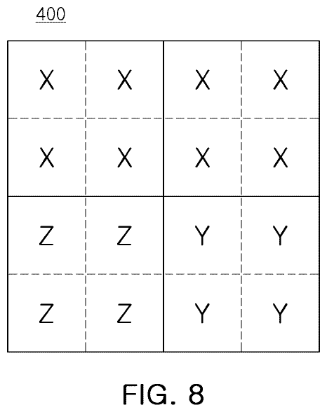

FIG. 7 illustrates selection and verification of a design model to be verified according to an example embodiment of the disclosure.

An image sensor design system may include a design data analysis system and a design model generation system. The design data analysis system may select design model candidates and transmit the same to the design model generation system. The design model generation system may select a design model to be verified from the design model candidates and verify the selected design model. Hereinafter, the operation (in which the design model generation system selects a design model to be verified and verifies the selected design model) is described in detail. The operation may correspond to operation S120 of FIG. 5. Specific example embodiments of the image sensor design system may be similar to those described above in FIGS. 4 to 6.

The design model may include a pixel model and a circuit model, and the circuit model may include an analog circuit model and a digital circuit model. The pixel model may include design data such as the type and disposition of color filters of driving unit pixels, and the presence and absence and size of micro lenses. The analog circuit model may include design data for a photodiode, disposition and connection information of elements, or the like. The digital circuit model may include design data for a clock signal, a digital pattern, and the like. Specific examples of the design model may be similar to those described above in FIGS. 1 to 3.

The design model generation system can perform first to third designs and first to third verifications cross-sectionally, and then perform overall verification. The first design and the first verification may be performed for each of the pixel model, the analog circuit model, and the digital circuit model. The second design and second verification may be performed by merging the pixel model or the digital circuit model. The third design may be performed for each of the pixel model, the analog circuit model, and the digital circuit model. The third verification and overall verification may be performed by merging pixel models or digital circuit models.

Referring to FIG. 7, the first design and the first verification may be performed for a single driving unit pixel for each of the pixel model and the digital circuit model. Specific examples of the single driving unit pixel may be similar to those described above with reference to FIG. 2. The first design and the first verification for each of the pixel model and the digital circuit model may be performed simultaneously.

The design model generation system may select a design model to be verified from design model candidates and select a driving unit pixel. For example, a size of the driving unit pixel and whether it is a micro lens may be determined. Thereafter, the design model generation system may generate a single row or a single column of the pixel array. For example, a single row or a single column of the pixel array may be generated by repeatedly disposing the driving unit pixels in a size equal to that of the single row or the single column.

Simultaneously, the design model generation system may select a design model to be verified from the design model candidates and select a driving unit analog element. The selection of the driving unit analog element may include the selection of photodiodes and elements corresponding to the driving unit pixels. Thereafter, the design model generation system may generate an analog circuit corresponding to a single row or a single column of the pixel array. For example, the driving unit analog elements are repeatedly disposed in a size equal to that of the single row or the single column, and a readout circuit and a multiplexer (MUX) receiving a reset voltage and a signal voltage from the pixels may be additionally disposed.

At the same time, the design model generation system may select a design model to be verified from the design model candidates and select a digital signal corresponding to a single row or a single column. For example, a clock signal and a digital pattern for operating an analog circuit corresponding to a row or column may be selected.

After a first design is completed, a first verification may be performed. The design model generation system may perform verification on a row or column basis for each of a pixel model or a digital circuit model simultaneously. In the pixel model, it can be determined in the first verification whether the driving unit pixel included in the row or column generated in the first design do not overlap and whether the driving unit pixels that are repeatedly disposed are not missing.

In the analog circuit model, it can be verified whether elements included in the analog circuit corresponding to the row or column generated in the first design are disposed without overlapping, whether elements are not missing, and whether elements are accurately connected to each other. In the digital circuit model, it can be verified whether digital signals corresponding to the row or column generated in the first design are not duplicated and whether there is no disconnection in the digital signals.

Referring to FIG. 7, for a column or row in which a pixel model or a digital circuit model is merged, a second design and a second verification may be performed. When the pixel model or the digital circuit model passes the first verification, a second design and a second verification may be performed. When at least one of the pixel model and/or digital circuit model fails the first verification, the first design for the pixel or circuit that has failed the first verification may be performed again.

The design model generation system may perform a second design by disposing the pixel model and the analog circuit model that have passed the first verification together. Specifically, the second design may include a design of disposing a layout of the pixel model of a single row or a single column and a layout of the analog circuit together. Thereafter, the design model generation system may perform a second verification to determine whether the pixel model and the analog circuit of a single row or single column are properly disposed with each other and electrically connected.

When the pixel model or the digital circuit model passes the second verification, a third design and third verification may be performed. When at least one of the pixel model or the digital circuit model fails the second verification, a second design may be performed again for the pixel or circuit that have failed the second verification. Referring to FIG. 7, the third design may be performed for each of the pixel models or the digital circuit models, and the third verification may be performed by merging the pixel models or the digital circuit models.

For example, referring to FIG. 3 together, the third verification may include verification of whether the micro lens 105, the color filter 103, the first layer L1, and the second layer L2 are disposed to overlap in a third direction. In addition, the third verification may include verification of whether the photodiode PD, elements 110 and 140, metal wiring 111, and top wirings 115 and 155 are connected to each other.

The design model generation system may simultaneously perform a third design for each of the pixel models or digital circuit models that has passed the second verification. Specifically, the third design may include a design reflecting a design of the pixel array, peripheral circuit, and overall digital circuit for the image sensor, as well as a special function thereof. The special function may include an autofocus function, a color temperature, and the like.

In the pixel model, the design model generation system may generate a pixel array by repeatedly disposing rows or columns that have passed the second verification. Specific examples of the pixel array may be similar to those described above with reference to FIG. 3. Thereafter, the design model generation system may select special pixels performing special functions and reflect the same in the pixel array.

In the analog circuit model, the design model generation system may generate peripheral circuits by repeatedly disposing rows or columns that have passed the second verification. Specific examples of the peripheral circuits may be similar to those described above with reference to FIG. 3. In addition, the third design may include a design of disposing a layout of the peripheral circuit in a layout of the pixel array. Thereafter, the design model generation system may select a special analog circuit performing a special function and reflect the same in the peripheral circuit.

In the digital circuit model, the design model generation system may generate an overall digital signal using a digital signal corresponding to a row or column that has passed the second verification. The overall digital signal may correspond to all digital signals for all pixels included in the pixel array. Thereafter, the design model generation system may select a special digital signal performing a special function and reflect the same in the overall digital signal.

Thereafter, the design model generation system may perform a third verification, including whether the pixel array and peripheral circuit are appropriately disposed with each other and whether special functions thereof operate normally.

The design model generation system may perform overall verification by merging pixel models or digital circuit models that have passed the third verification. The design model generation system may merge pixel models or digital circuit models that have passed the third verification and select the same as a design model to be verified. The design model generation system may verify whether the image sensor to which the deign model to be verified is applied is operating normally overall.

Referring to operations S130 and S140 of FIG. 5 together, when the design model to be verified passes the overall verification, the design model to be verified may be selected as a final design model. When the design model to be verified fails the overall verification, a third design for at least one of the pixel model and the digital circuit model may be performed again.

By performing design and verification operations cross-sectionally, the reliability of the design may be improved. In addition, when design results are not suitable, the design can be modified before the design model to be verified is selected, which can shorten the time required to select the final design model.

The design model generation system of the example embodiment illustrated in FIG. 7 may perform design and verification cross-functionally. However, the disclosure is not limited thereto, the design model generation system may perform verification between at least one of the first to third designs.

The pixel model and circuit model of the example embodiment illustrated in FIG. 7 may be designed by a design model generation system. Alternatively, a pixel model may be designed by a user, and a circuit model may be designed by a design model generation system. Alternatively, the user may perform first design and first verification on the pixel model and circuit model, and the design model generation system may perform second design or overall verification on the pixel model and circuit model. However, this may not be limited thereto.

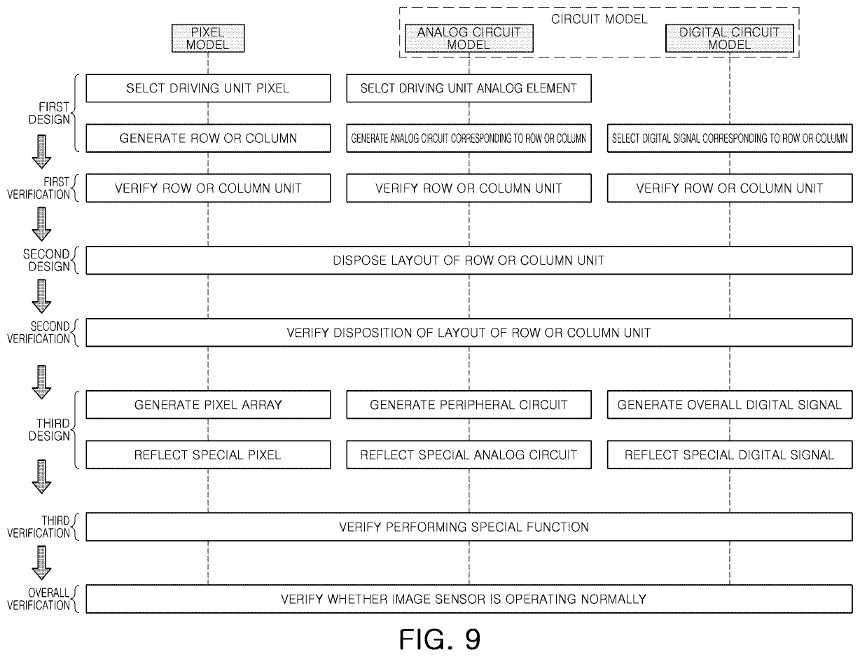

FIGS. 8 and 9 are drawings provided to illustrate a first design for a driving unit pixel according to example embodiments of the disclosure.

First, referring to FIG. 8, a unit driving pixel 300 may include four pixels disposed in a 2×2 configuration. In an example embodiment illustrated in FIG. 8, a driving unit pixel and/or a driving unit analog element may be selected for each of the four pixels. At least one of the four pixels may have design data for different image sensors selected as a driving unit pixel and/or a driving unit analog element.

When FIG. 8 illustrates a driving unit pixel, a pixel of an image sensor X may be selected as driving unit pixels for two pixels, and a pixel of an image sensor Y and image sensor Z may be selected as driving unit pixels for each of the remaining pixels. When FIG. 8 illustrates a driving unit analog element, the analog element of the image sensor X may be selected as the driving unit analog elements for two pixels, and the analog elements of the image sensor Y and the image sensor Z may be selected as the driving unit analog elements for each of the remaining pixels. In this case, the driving unit pixel and the driving unit analog element for a single driving unit pixel may be selected differently.

Referring to FIG. 9, the unit driving pixel 400 may include 16 pixels disposed in a 4×4 configuration. In the example embodiment illustrated in FIG. 8, a driving unit pixel and/or a driving unit analog element may be selected for each of the 16 pixels. At least one of the sixteen pixels may have design data for different image sensors selected as a driving unit pixel and/or a driving unit analog element.

When FIG. 9 illustrates a driving unit pixel, a pixel of an image sensor X may be selected as driving unit pixels for eight pixels, a pixel of an image sensor Y may be selected as driving unit pixels for four pixels, and a pixel of an image sensor Z may be selected as the driving unit pixels for four pixels.

When FIG. 9 illustrates a driving unit analog element, an analog element of the image sensor X may be selected as driving unit analog elements for eight pixels, an analog element of the image sensor Y may be selected as driving unit analog elements for four pixels, and an analog elements of the image sensor Z may be selected as the driving unit analog elements for four pixels. In this case, the driving unit pixel and the driving unit analog element for a single driving unit pixel may be selected differently.

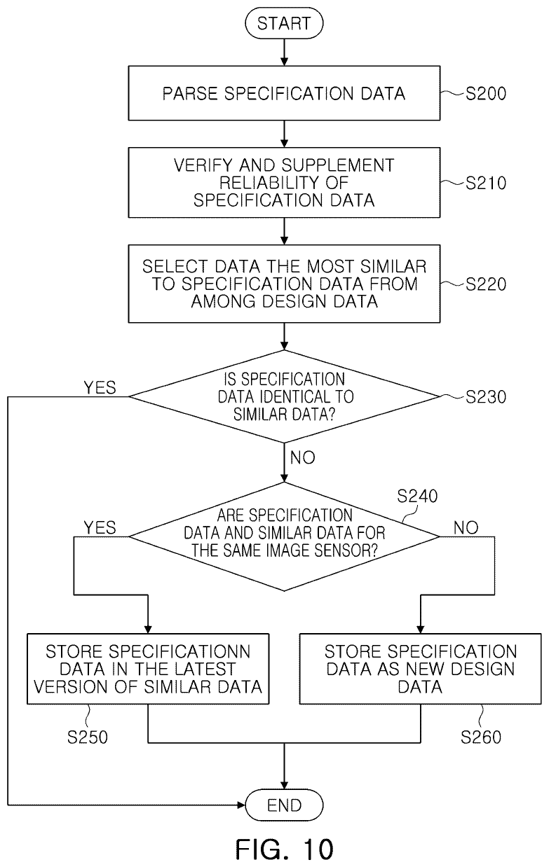

FIG. 10 illustrates a process of inputting specification data according to an example embodiment of the disclosure.

Specific example embodiments of an image sensor design system may be similar to those described above in FIGS. 1 to 9. After a final design model is selected, the specification data and the final design model may be stored in a database. For example, a data classification unit may parse and classify the specification data and store the same in the database, which can correspond to operation S100 of FIG. 5. Hereinafter, a process of the data classification unit classifying the specification data is described.

The data classification unit may parse the input specification data (S200). The data classification unit can include a parser. The parser may analyze the input specification data according to a specific format and extract the necessary data. For example, the parser may extract specification data by specification, and reprocess the specification data into a specified format.

Thereafter, the data classification unit may verify and supplement the reliability of the reprocessed specification data (S210). The data classification unit may determine whether the reprocessed specification data includes missing or damaged data and convert the same into suitable data. For example, if data for a pixel size includes characters, the data classification unit may determine that the data is damaged data. As another example, if the number of digits in data for a size of the image sensor exceeds a maximum allowed value, the data classification unit can determine that the data is damaged data.

The data classification unit may select similar data most similar to the specification data from among the design data stored in the database (S220). The design data may include specification data of previously designed image sensors. The data classification unit may select specification data of an image sensor including the most identical specification data as similar data. Alternatively, the data classification unit may select specification data of the image sensor including the most similar specification data as similar data.

The data classification unit may determine whether the specification data and similar data are identical (S230). When specific data for each of the specifications are all identical, it can be determined that the specification data and similar data are identical (YES in S230). In other words, the case may be a case that the data identical to the specification data is stored in design data. Therefore, the specification data may not be repeatedly stored in the database as the design data.

When at least one of the specific data for each of the specifications is different, it can be determined that the specification data and the similar data are not identical (NO of S230). When the specification data and similar data are for the same image sensor (YES in S240), the data classification unit may store the specification data as the latest version of the similar data (S250). After a final design model is selected for the specification data, the specification data and the final design model may be stored in a database as the latest version of similar data.

When the specification data and similar data are not for the same image sensor (NO of S240), the data classification unit may store the specification data as new design data (S260). Since the specification data is similar to the similar data but is not data for the same image sensor, the specification data may be data for an image sensor which is not stored in the database. Therefore, after the final design model is selected for the specification data, the specification data and the final design model for the same may be stored as new design data in the database.

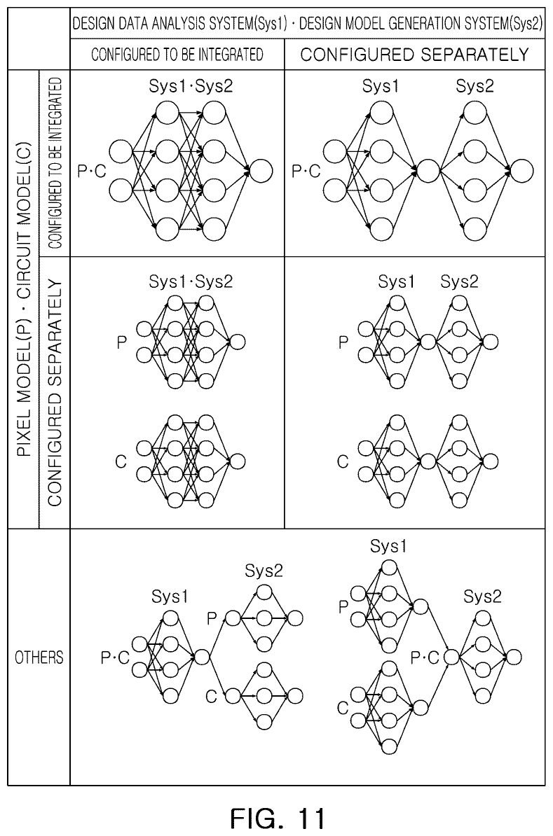

FIG. 11 is a diagram illustrating an image sensor design system according to example embodiments of the disclosure.

The image sensor design system may include a design data analysis system (Sys1) and a design model generation system (Sys2). A final design model may be generated by dividing the same into a pixel model (P) and a circuit model (C). The circuit model (C) may include an analog circuit model and a digital circuit model. Specific example embodiments of the image sensor design system may be similar to those described above in FIGS. 1 to 10.

The design data analysis system (Sys1) and the design model generation system (Sys2) may be configured to be integrated or separately. The design data analysis system (Sys1) and the design model generation system (Sys2), which are configured to be integrated, may include a single learning model. The design data analysis system (Sys1) and the design model generation system (Sys2), which are configured separately, may include different learning models.

When the design data analysis system (Sys1) and the design model generation system (Sys2) are configured to be integrated, the learning model may be simple and the learning speed may be fast. The learning model may be Conditional Generative Adversarial Networks (cGAN), Variational Autoencoders (VAE), or Sequence-to-Sequence (Seq2Seq).

When the design data analysis system (Sys1) and the design model generation system (Sys2) are configured separately, the functions thereof may be separated and the learning model may be sophisticated. In addition, each system may be improved independently and various final learning models may be generated. The design data analysis system (Sys1) may be an autoencoder, a Siamese network, or a Triplet Network (NCF, Neural Collaborative Filtering). The design model generation system (Sys2) can be a Conditional GAN (cGAN), a Conditional Variational Autoencoder (cVAE), a Conditional Diffusion Model, a Transformer-based Model such as GPT-3 and BERT, or a Recurrent Neural Network (RNN).

As another example, the design data analysis system (Sys1) and the design model generation system (Sys2) may use statistical techniques. The design data analysis system (Sys1) may use statistical techniques such as the K-Nearest Neighbors (KNN) algorithm, Principal Component Analysis (PCA), or the like. The design model generation system (Sys2) may use statistical techniques such as Regression Analysis, Gaussian Processes, Principal Component Regression, or the like.

As another example, one of the design analysis system (Sys1) and the design model generation system (Sys2) may use a learning model, and the other one thereof may use statistical techniques.

A pixel model (P) and a circuit model (C) may be configured to be integrated or be separately configured. The pixel model (P) and the circuit model (C), which are configured to be integrated, may be selected as a final design model by a single learning model. The pixel model (P) and the circuit model (C), which are separately configured, may be selected as a final design model by different learning models.

The learning model may be a model learned using an artificial intelligence algorithm, such as a machine learning, neural network, deep learning algorithm, or the like. Alternatively, the learning model may be a model learned using statistical methods.

Referring to the image sensor design system of FIG. 11 (a), the design data analysis system (Sys1) and the design model generation system (Sys2) are configured to be integrated, and the pixel model (P) and the circuit model (C) may also be configured to be integrated. In other words, the image sensor design system may include a single learning model. The single learning model may be trained to receive specification data and select a final design model corresponding to the specification data. In this case, the final design model may include both a pixel model (P) and a circuit model (C).

Referring to the image sensor design system of FIG. 11 (b), the design data analysis system (Sys1) and the design model generation system (Sys2) may be configured separately, and the pixel model (P) and the circuit model (C) may be configured to be integrated. The image sensor design system of FIG. 11 (b) may correspond to the example embodiments described above in FIGS. 1 to 10.

The learning model of the design data analysis system (Sys1) may receive specification data and select design model candidates. The learning model of the design model generation system (Sys2) may select a design model to be verified from the design model candidates and verify the same to select a final design model. In this case, the final design model may include both a pixel model (P) and a circuit model (C).

Referring to the image sensor design system of FIG. 11 (c), the design data analysis system (Sys1) and the design model generation system (Sys2) may be configured to be integrated, and the pixel model (P) and the circuit model (C) may be configured separately. The learning model of the pixel model (P) may be trained to receive specification data, and select a final design model of the pixel model (P). The learning model of the circuit model (C) may be trained to receive specification data and select a final design model of the circuit model (C). That is, the final design model may be selected by being divided into a pixel model (P) and a circuit model (C).

Referring to the image sensor design system of FIG. 11 (d), the design data analysis system (Sys1) and the design model generation system (Sys2) may be configured separately, and the pixel model (P) and the circuit model (C) may also be configured separately.

The learning model of the pixel model (P) and design data analysis system (Sys1) may receive specification data and select design model candidates of the pixel model (P). The learning model of the pixel model (P) and design model generation system (Sys2) may select a design model to be verified from the design model candidates of the pixel model (P) and verify the same and select a final design model of the pixel model (P).

The learning model of the circuit model (C) and design data analysis system (Sys1) may receive specification data, and select design model candidates for the circuit model (C). The learning model of the circuit model (C) and design model generation system (Sys2) may select a design model to be verified from the design model candidates of the pixel model (P) and verify the same and select a final design model for the circuit model (C).

That is, the final design model may be selected by being divided into a pixel model (P) and a circuit model (C).

Referring to the image sensor design system of FIG. 11 (e), the design data analysis system (Sys1) and the design model generation system (Sys2) may be configured separately. In the design data analysis system (Sys1), the pixel model (P) and the circuit model (C) may be configured to be integrated to select a design model candidate. In the design model generation system (Sys2), the pixel model (P) and the circuit model (C) may be configured separately, and the final design model may be selected by being divided into the pixel model (P) and the circuit model (C).

Referring to the image sensor design system of FIG. 11 (f), the design data analysis system (Sys1) and the design model generation system (Sys2) may be configured separately. In the design data analysis system (Sys1), the pixel model (P) and the circuit model (C) may be configured separately, and the design model candidates may be selected by being divided into the pixel model (P) and the circuit model (C). In the design model generation system (Sys2), the pixel model (P) and the circuit model (C) may be configured to be integrated, and the final design model may include both the pixel model (P) and the circuit model (C).

However, the configuration of the design data analysis system (Sys1), the design model generation system (Sys2), the pixel model (P), and the circuit model (C) may not be limited thereto.

As set forth above, according to an example embodiment of the disclosure, by analyzing design data of a pixel and a circuit of an image sensor stored in a database and selecting a final design model suitable for the specification data of the image sensor, the time required to design an image sensor may be shortened and the design quality of the image sensor may be improved.

The various and beneficial advantages and effects of the disclosure are not limited to the above-described content, and may be more easily understood through description of specific embodiments of the disclosure.

While example embodiments have been illustrated and described above, it will be apparent to those skilled in the art that modifications and variations could be made without departing from the scope of the disclosure as defined by the appended claims.

The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

What is claimed is:

1. A design method of an image sensor, the design method comprising:
determining a degree of similarity between specification data of each of a plurality of image sensors in a database and specification data of an image sensor to be designed;
selecting, based on the specification data of the image sensor to be designed and the degree of similarity with the image sensor to be designed, at least two image sensors from among the plurality of image sensors, wherein the at least two image sensors correspond to design model candidates;
selecting a design model to be verified by combining the design model candidates corresponding to the at least two image sensors and verifying whether the design model to be verified operates normally; and
selecting the design model to be verified, which is operating normally, as a final design model.

2. The design method of claim 1, wherein a machine learning model or a statistical learning model is configured to perform:
the determining the degree of similarity,
the selecting the at least two image sensors, and
the verifying whether the design model to be verified operates normally.

3. The design method of claim 2, wherein the machine learning model is learned using a neural network technique.

4. The design method of claim 1, wherein the selecting the design model to be verified, comprises:
selecting a pixel model candidate of the image sensor to be designed; and
selecting a circuit model candidate of the image sensor to be designed.

5. The design method of claim 4, wherein the circuit model candidate comprises an analog circuit model candidate and a digital circuit model candidate.

6. The design method of claim 5, wherein the pixel model candidate and the circuit model candidate are selected for a driving unit pixel that corresponds to a minimum unit, that operates independently, and that comprises at least one pixel.

7. The design method of claim 6, wherein the pixel model candidate comprises at least one of a size of the at least one pixel in the driving unit pixel, information on a microlens, information on a color filter, and a color of the color filter.

8. The design method of claim 6, wherein the analog circuit model candidate comprises at least one of a design of a plurality of elements in the driving unit pixel, a disposition of the plurality of elements, connection information of the plurality of elements, a design of a photodiode, and a disposition of a plurality of metal wirings.

9. The design method of claim 6, wherein the digital circuit model candidate comprises at least one of a clock signal and a digital pattern for operating a single row or a single column in which the driving unit pixel is repeatedly disposed.

10. The design method of claim 5, further comprising:
verifying a layout of the pixel model candidate;
verifying a layout of the analog circuit model candidate; and
verifying at least one of whether a signal of the digital circuit model candidate is duplicated or whether the signal is disconnected.

11. The design method of claim 1, wherein the specification data of the image sensor to be designed is input in a file format.

12. A design method of an image sensor, comprising:
determining a degree of similarity between specification data of each of a plurality of image sensors in a database and specification data of an image sensor to be designed;
selecting, based on the degree of similarity, a pixel model candidate and a circuit model candidate, from among design models of each of the plurality of image sensors in the database;
verifying each of the pixel model candidate and the circuit model candidate, merging the pixel model candidate and the circuit model candidate, and verifying whether the merged model candidate operates normally; and
merging the pixel model candidate and the circuit model candidate that are verified and selecting the merged pixel model candidate and the circuit model candidate as a final design model of the image sensor to be designed.

13. The design method of claim 12, wherein the circuit model candidate comprises an analog circuit model candidate and a digital circuit model candidate.

14. The design method of claim 13, wherein the analog circuit model candidate comprises at least one of a design of a plurality of elements, a disposition of the plurality of elements, connection information of the plurality of elements, a design of a photodiode, and a disposition of a plurality of metal wirings.

15. The design method of claim 13, wherein the digital circuit model candidate comprises at least one of a clock signal and a digital pattern for operating a single row or a single column in which a driving unit pixel is repeatedly disposed.

16. The design method of claim 12, wherein the specification data comprises data on specifications of the image sensor to be designed, and
wherein the specifications of the image sensor to be designed comprise at least one of a size of the image sensor to be designed, a pixel size, and an effective resolution of the image sensor to be designed.

17. The design method of claim 12, wherein the pixel model candidate comprises at least one of a size of a pixel in the image sensor to be designed, information on a microlens, information on a color filter, and a color of the color filter.

18. A design method of an image sensor, comprising:
a first design step of selecting a driving unit pixel for each of pixel models and circuit models, using specification data and design models of each of a plurality of image sensors in a database, and generating a single row or a single column by repeatedly disposing a design of the driving unit pixel;
a second design step of generating a row layout or a column layout by merging and repeatedly disposing the pixel models and the circuit models for the single row or the single column;
a first verification step of verifying a structure of the row layout or the column layout;
a third design step of generating a pixel array and peripheral circuits using the row layout or the column layout, reflecting a special pixel and a special circuit, and performing a special function into each of the pixel array and the peripheral circuits;
a second verification step of verifying a performance of the special function of the pixel array and the peripheral circuits in which the special pixel and the special circuit are reflected; and
an overall verification step of merging the pixel array and the peripheral circuits in which the special pixel and the special circuit are reflected and verifying whether the merged circuit of the pixel array and the peripheral circuits operates normally.

19. The design method of claim 18, further comprising a step of re-performing one design step performed immediately before, among the first to third design steps, in a state in which at least one of the first to third verification steps fails to pass.

20. The design method of claim 18, further comprising a step of selecting the pixel array and the peripheral circuits in which the special pixel and the special circuit are reflected as a final design model of the image sensor to be designed, when the overall verification step is passed.
